(19) United States
(12) Patent Application Publication
(10) Pub. No.: US 2025/0360563 A1
(43) Pub. Date: Nov. 27, 2025

(54) APPARATUS AND METHOD FOR PRODUCING AN OBJECT BY MEANS OF ADDITIVE MANUFACTURING

(71) Applicant: TECHNISCHE UNIVERSITEIT EINDHOVEN, Eindhoven (NL)

(72) Inventors: Frank Petrus Adrianus VAN BERLO, Eindhoven (NL); Lambèrt Cécile Angelo VAN BREEMEN, Eindhoven (NL); Patrick David ANDERSON, Eindhoven (NL)

(21) Appl. No.: 18/867,531

(22) PCT Filed: May 22, 2023
(86) PCT No.: PCT/NL2023/050288

§ 371 Date: Nov. 20, 2024

(30) Foreign Application Priority Data
Jun. 1, 2022 (NL) 2032044

(51) Int. Cl. B22F 10/36; B22F 10/28; B29C 64/153; B29C 64/264; B29C 64/364; B29C 64/393; B33Y 10/00; B33Y 30/00; B33Y 40/00; B33Y 50/02

(52) U.S. Cl. CPC B22F 10/36; B22F 10/28; B29C 64/153; B29C 64/264; B29C 64/364; B29C 64/393; B33Y 10/00; B33Y 30/00; B33Y 40/00; B33Y 50/02

(57) ABSTRACT

An apparatus and a method for producing an object by means of additive manufacturing, the apparatus comprising:—a process chamber arranged for receiving in a build space of the process chamber a bath of material arranged for producing the object;—a ultrasound source element arranged for emitting a beam of focused ultrasound energy in the build space for processing a selective part of the material of the bath of material for producing the object;—a control unit, communicatively coupled to the ultrasound source element, arranged for controlling the ultrasound source element such that a frequency and/or amplitude of the beam of focused ultrasound energy is set at a predetermined frequency and/or predetermined amplitude taking into account a characteristic of material of the bath of material in a focus spot of the beam of focused ultrasound energy and/or such that a frequency and/or an amplitude of the beam of focused ultrasound energy is/are set at a predetermined value, preferably the predetermined frequency and/or the predetermined amplitude, taking into account a focus distance of the beam of focused ultrasound energy.

According to a first aspect the present disclosure relates to an apparatus for producing an object by means of additive manufacturing.

According to a second aspect, the present disclosure relates to a method for producing an object by means of additive manufacturing.

It is known that materials such as polymers, metals and liquids can absorb energy such as waves of light or ultrasound. The absorption of energy may result in an increase of the temperature of the material.

In selective laser sintering, the heating of material, such as polymer powders, is crucial, because the object is manufactured by melting and/or fusing of the powder particles together for producing the object.

The apparatus according to the present disclosure comprises:
a process chamber arranged for receiving in a build space of the process chamber a bath of material arranged for producing an object;
an ultrasound source element arranged for emitting a beam of focused ultrasound energy in the build space for processing a selective part of the material of the bath of material for producing the object;
a control unit, communicatively coupled to the ultrasound source element, arranged for controlling the ultrasound source element for producing the object.

Preferably, the control unit is arranged for controlling the ultrasound source element such that a frequency and/or an amplitude of the beam of focused ultrasound energy is set at a predetermined value, preferably a predetermined frequency and/or a predetermined amplitude, taking into account a characteristic of material of the bath of material in a focal spot of the beam of focused ultrasound energy and/or such that a frequency and/or an amplitude of the beam of focused ultrasound energy is/are set at a predetermined value, preferably the predetermined frequency and/or the predetermined amplitude, taking into account a focus distance of the beam of focused ultrasound energy.

In one embodiment, an ultrasound source element includes a plurality of sources of ultrasound energy, such as ultrasound transducers, capable of being controlled separately. In some embodiments, the phase difference and/or time delay between transmissions of the sources and/or elements can be controlled to focus and steer the ultrasound beam. One exemplary source of ultrasound energy is a phased array ultrasound transducer.

The present disclosure relies at least partly on the insight that by using a focussed ultrasound source instead of a laser to heat the material, the frequency and/or amplitude of the ultrasound source can be electronically controlled. The amount of energy absorbed and the increase of temperature of the material depends on the material and the wavelength applied to the material.

Preferably, the wavelength or frequency and/or the amplitude of the ultrasound energy is tuned so as to achieve the optimum processing conditions of the target material.

For example if a polymer like nylon is irradiated with a green laser emitting a wavelength of 0.55 μm, the polymer will absorb less than 5% of the energy emitted by the green laser. However, if nylon is irradiated with an infrared laser with a wavelength of 10.6 μm, the nylon will absorb approximately 95% of the energy emitted by the infrared laser and therefore may result in a relative large temperature increase of the nylon, at least at a location that is irradiated by the infrared laser.

By controlling the frequency of the beam of focused ultrasound energy the absorption of energy emitted by the beam of focused ultrasound energy can be tuned thereby allowing to use different materials during the manufacturing of a single object.

By using the ultrasound source element of the present disclosure, the resulting ultrasound field can be controlled electronically. Instead of scanning layer-by-layer as is common practice for additive manufacturing processes such as selective laser sintering, the use of the apparatus and method according to the present disclosure allows the user to optimize the processing strategy.

The apparatus according to the present disclosure allows for a completed bath of material to be used instead of applying layers of material during the build of the object. By focussing the focused beam of ultrasound energy inside the bath of material, the material can be processed with volumetric focussing instead of focussing on a plane. Hence, an object can be produced directly inside the bath of material without the use of any spreading devices to distribute the material during production of the object. This is beneficial for realising a relative short processing time for producing the object.

A further benefit of focussing the beam of ultrasound energy inside the bath of material is that the temperature of the bath of material may be maintained relatively stable in a practical manner as compared to an approach where layers are added to the bath of material during production of the object.

It is beneficial if the characteristic of material of the bath of material is a frequency dependent acoustic absorption of propagating ultrasound waves. On one hand, if the absorption of the material is relatively low, the ultrasound beam can penetrate the material relatively easily. However, then the heating rate at the spot is also relatively low. On the other hand, if the absorption of the material is relatively high, most of the energy is absorbed before reaching the spot and the heating rate is also low at the focal spot. Hence, an optimum needs to be found to achieve the sufficient depth of penetration, as well as sufficient heating rate.

Preferably, the predetermined frequency is in the range of 0.02-100 MHz, preferably 0.1-100 MHz. However, the preferred frequency should be selected based on the material to be processed and the desired focal spot size.

In an embodiment the apparatus comprises a compacting arrangement arranged for compacting the bath of material provided in the process chamber.

Preferably, the control unit is arranged for controlling the ultrasound source element such that the beam of focused ultrasound energy is moveable within the bath of material for producing the object. A benefit of using ultrasound is that by using the ultrasound source elements according to the present disclosure, the beam can be electronically steered and focused. This is beneficial for avoiding the need for moving components such as a galvo scanner that is commonly used for moving a laser beam in an apparatus for selective laser sintering. This is beneficial for realising a relative high scanning speed and accuracy of positioning of the focused beam of ultrasound energy.

It is beneficial, if the apparatus comprises a movement arrangement arranged for moving the one or more ultrasound source elements according to the present disclosure along an outer wall and/or an inner wall of the process chamber. This is beneficial for processing flexibility, such as for allowing to produce a relative large object or another specific type of an object.

Preferably, the apparatus further comprises a temperature management arrangement, communicatively coupled to the control unit, for heating and/or cooling the process chamber to a predetermined temperature. This is beneficial for avoiding the need for heating the material to a relative large extent by the beam of focused ultrasound energy. However, in some embodiments, the material can be pre-heated with one or more ultrasound source elements.

In an embodiment, the temperature management arrangement comprises a cooling and/or heating medium.

The predetermined temperature or temperature profile or regime is defined to achieve the desired processing conditions of the material. For example, the predetermined temperature can be in the range of 5° C.-25° C. below a temperature for inducing a phase transition or for curing, melting and/or fusing, or otherwise processing, a selective part of the material of the bath of material for producing the object.

In an embodiment the ultrasound source element is further arranged for receiving an echo from the build space originating from a reflection of the beam of focused ultrasound energy and arranged for outputting an output signal comprising data related to the echo received, wherein the apparatus further comprises:

a determining unit, communicatively coupled to the ultrasound source element, arranged for receiving the output signal and processing the data related to the echo for determining a parameter of the bath of material.

In this regard, it is beneficial if the determining unit is communicatively coupled to the control unit and further arranged for providing control data to the control unit for controlling the ultrasound source element taking into account the parameter determined by the determining unit. It is advantageous, if an inner wall and/or an outer wall of the process chamber includes curved segments, for example, such that at least a portion of the build space has a spherical shape and/or a cylindrical shape. This is beneficial for optimizing process conditions in the process chamber. In particular, reduction of the focus depth in order to reduce the amount of energy needed to heat the spot that is being processed is an important factor. In some embodiments, this objective can be achieved with providing a plurality of flat segments on an inner wall and/or an outer wall of the process chamber, such as to form a cube or another shape having a polygonal cross section.

Preferably, the apparatus further comprises a plurality of ultrasound source elements. This is beneficial for allowing to realise a relative short processing time for producing the object and to generate more energy.

In this regard, it is advantageous if the control unit is arranged for controlling the plurality of ultrasound source elements simultaneously for producing the object using a plurality of beams of focused ultrasound energy emitted by the plurality of ultrasound source elements.

Each of the plurality of beams of focused ultrasound energy may be directed to a different position in the bath of material, so as to form a plurality of focal spots. Such embodiments can be advantageously used to make holograms. Alternatively, at least two or all of the plurality of beams of focused ultrasound energy may be directed to the same position in the bath of material, so as to form one focal spot.

The process chamber can be arranged for receiving any suitable type of material for producing the object. In one embodiment, the process chamber is arranged for receiving at least one of a powder material and a powder/filler combination comprising the material for producing the object. Because there is no need for adding a material layer during the production of the object it is also possible use a combination of a medium-particles phase. This implies that a liquid or particle suspension in liquid may be received in the process chamber for producing the object.

Selective laser sintering requires the product to be build up layer-by-layer. However, the apparatus according to the present disclosure allows to scan inside a volume. Therefore, no powder has to be spread by a blade or roller. Removing this step from the process significantly increase printing speed. Moreover, this solves the problem of wiping or distorting parts from the powder bed. Additionally, the properties of the powder can be completely different, because flowability of the powder is no longer a requirement. The apparatus may for instance hold different materials simultaneously during production of the object, the materials having for example different particle sizes, different molecular weights. The advantage is that the material properties may be tuned and a much wider range of materials (not limited to polymers as long as the sound is absorbed and converted to heat) may be used, including metals.

Another advantage of using a volume that needs no spreading is that, in case the material is provided in the form of powder, you can compress the powder. This can be used to tune the absorption properties of the beam of focused ultrasound energy. Moreover, this will improve the material properties of the produced object, since the volume fraction of pores is reduced, which results in less defects in the material and higher densities. Note that inducing pressure will result in material properties closer to properties obtained by injection moulding. Moreover, the unprinted powder can be reused without adding virgin powder. In selective laser sintering it is important to add virgin powder, since otherwise the flowability of the powder changes, which results in problems during spreading. Hence, this technique is more sustainable as the total amount of powder needed is less.

Using an ultrasound source element according to the present disclosure has some benefits compared to using a laser. First of all, the frequency of the element is adjustable and therefore tuneable. Since each material has a maximum absorption at a different frequency, it is possible to tune the absorption and hence this opens opportunities to use different kind of materials with the same apparatus. Moreover, this can be used to minimize the amount of energy needed to melt a certain polymer or to tune the heating rate. Additionally, the focus of the ultrasound source can be tuned by changing the frequency within a range wherein the material is absorbing the beam of focussed ultrasound energy. Increasing the frequency results in a smaller spot size. Hence, the resolution of a part can be tuned.

In case a plurality of ultrasound source elements are used, there is a possibility to simultaneously focus at multiple spots inside the bath of material. This increases print speed significantly and gives rise to different scan strategies. These scan strategies can be optimized to get favourable temperature histories inside the material, resulting in better part quality (less warpages and better properties).

In addition, an ultrasound source element can also receive signals. Hence, by recording the echoes it is possible to visualize the scanning inside the bath of material. These imaging techniques are widely used in medical applications. This imaging opens the opportunity to correct print parameters during or after the production of the object. Hence, the manufacturing procedure is tuneable so that the product is produced in the right manner the first time and every time. Adjustments of the print process are possible without removing the part and starting over again. This results in better sustainability, because less parts are disposed.

In an embodiment the apparatus comprises a first ultrasound source element/plurality of ultrasound source elements arranged for emitting a first beam of focused ultrasound energy and a second ultrasound source element/plurality of ultrasound source elements arranged for emitting a second beam of focused ultrasound energy, wherein the first beam of focused ultrasound energy is characterized by a first frequency and a first amplitude and the second beam of focused ultrasound energy is characterized by a second frequency and a second amplitude, the first frequency and/or amplitude being different from the second frequency and/or amplitude.

In an embodiment the plurality of ultrasound source elements are irregularly arranged.

In an embodiment the process chamber is arranged for receiving at least one of a powder material for producing the object and a mixture of the powder material for producing the object and a filler material, such as a liquid or solid filler material.

According to the second aspect, the present disclosure relates to a method for producing an object by means of additive manufacturing, the method comprising the steps of:

receiving, in a build space of a process chamber a bath of material arranged for producing the object;

emitting, by an ultrasound source element, a beam of focused ultrasound energy in the build space for processing a selective part of the material of the bath of material for producing the object;
controlling, by a control unit, the ultrasound source element for producing the object.

Embodiments of the apparatus according to the first aspect correspond to or are similar to embodiments of the method according to the second aspect of the present disclosure.

Effects of the apparatus according to the first aspect correspond to or are similar to effects of the method according to the second aspect of the present disclosure.

Preferably, during the step of controlling, the ultrasound source element is controlled such that a frequency and/or amplitude of the beam of focused ultrasound energy is set at a predetermined value(s), preferably a predetermined frequency and/or a predetermined amplitude, taking into account a characteristic of material of the bath of material in a focal spot of the beam of focused ultrasound energy and/or such that the frequency and/or the amplitude of the beam of focused ultrasound energy is set at a predetermined value(s), preferably the predetermined frequency and/or the predetermined amplitude, taking into account a focus distance of the beam of focused ultrasound energy.

In this regard, it may be advantageous if, during the step of controlling, the predetermined frequency is set to a frequency corresponding to 80% to 100% of a maximum of a frequency dependent acoustic absorption of propagating ultrasound waves of the material of the bath of material. However, in general, the frequency is set to achieve the desired processing conditions, which may be outside the abovementioned range.

Preferably, during the step of controlling, the predetermined frequency and/or amplitude is set such that absorption of the beam of focused ultrasound energy reduces for an increasing focus distance of the beam of focused ultrasound energy.

In a practical embodiment of the method according to the present disclosure, during the step of receiving, the bath of material received in the build space of the process chamber comprises two material fractions, wherein the acoustic absorption of propagating ultrasound waves is different for the two material fractions. This is beneficial for realising an object wherein the material properties of the object vary for different parts of the object.

Preferably, during the steps of emitting and controlling, the process chamber is heated and/or cooled, by a temperature management arrangement to a predetermined temperature. In some embodiments, the predetermined temperature is in the range of 5° C.-25° C. below a temperature for the desired type of processing the material, such as curing, melting and/or fusing, a selective part of the material of the bath of material for producing the object. This may be beneficial for avoiding the need for heating the material to a relative large extent by the beam of focused ultrasound energy. In other embodiments, the process chamber may be cooled, by a cooling arrangement, to a predetermined temperature.

Preferably, the method comprises the step of compacting the bath of material for producing the object. By compacting the bath of material, the number of pores in the end-product can be reduced, which increases mechanical properties and accuracy of the end-product. Alternatively, a filler medium can be used to improve mechanical properties of the end-product by for example post-treatment of the printed part.

In an embodiment the step of compacting is performed before the step of receiving.

In an embodiment the step of receiving comprises receiving at least one of a powder material for producing the object and a mixture of the powder material for producing the object and a filler material, such as a liquid or solid filler material.

In an embodiment the further comprises the step of moving the ultrasound source element relative to an outer wall and/or an inner wall of the process chamber for producing the object.

In an embodiment the method further comprises the steps of:
receiving the echo from the build space originating from the reflection of the beam of focused ultrasound energy;
outputting an output signal comprising data related to the echo received; and
determining a parameter of the bath of material.

In this regard, it is advantageous if the method further comprises the step of:
providing control data to the control unit for controlling the ultrasound source element taking into account the parameter.

The present disclosure will now be explained by means of a description of an embodiment of an apparatus in accordance to the first aspect and a method according to the second aspect, in which reference is made to the following schematic figures, in which:

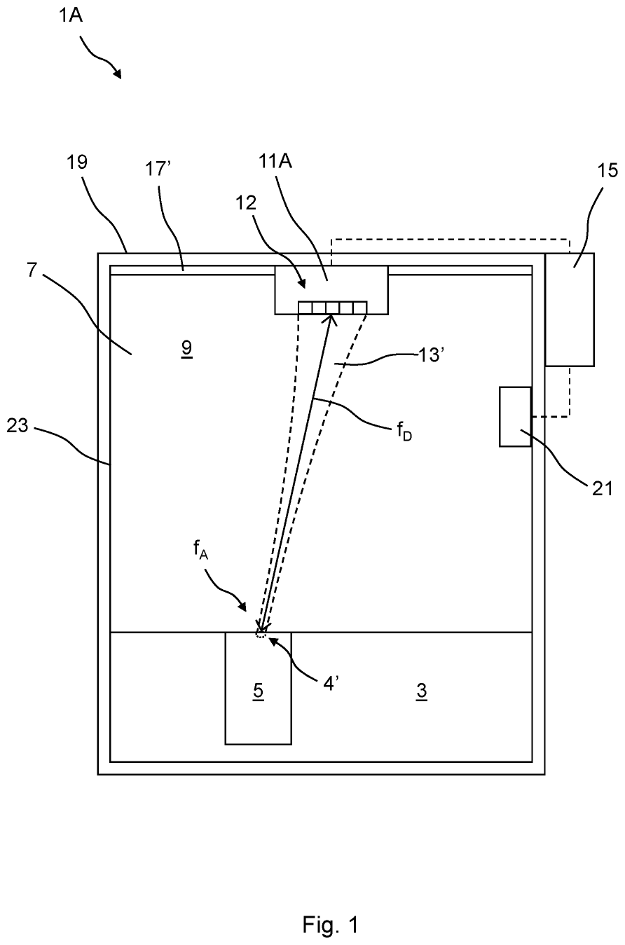

FIG. 1 shows schematically an embodiment of an apparatus for producing an object by means of additive manufacturing, according to the first aspect of the present disclosure;

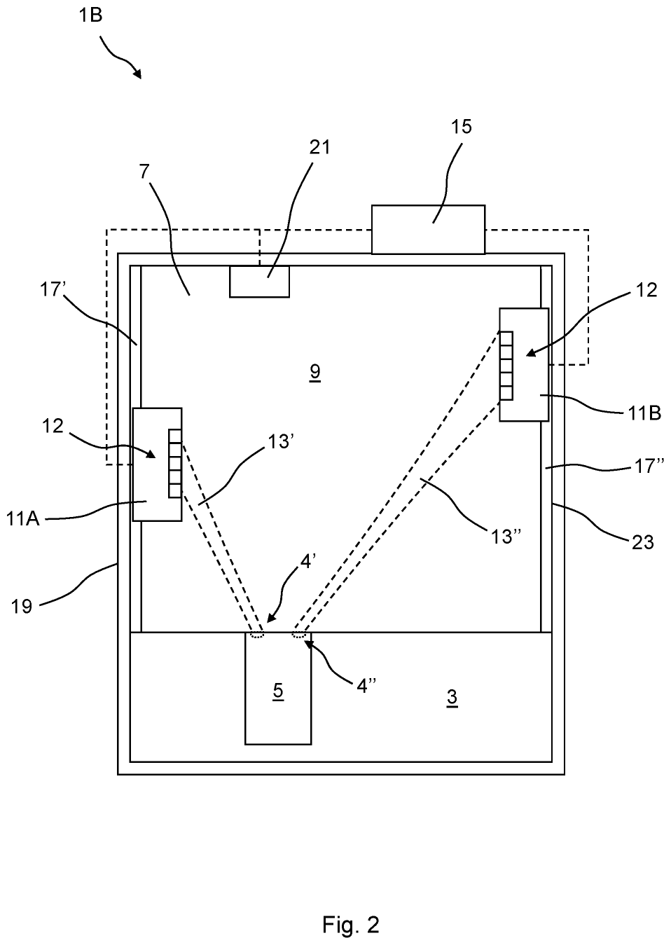

FIG. 2 shows schematically another embodiment of an apparatus for producing an object by means of additive manufacturing, according to the first aspect of the present disclosure;

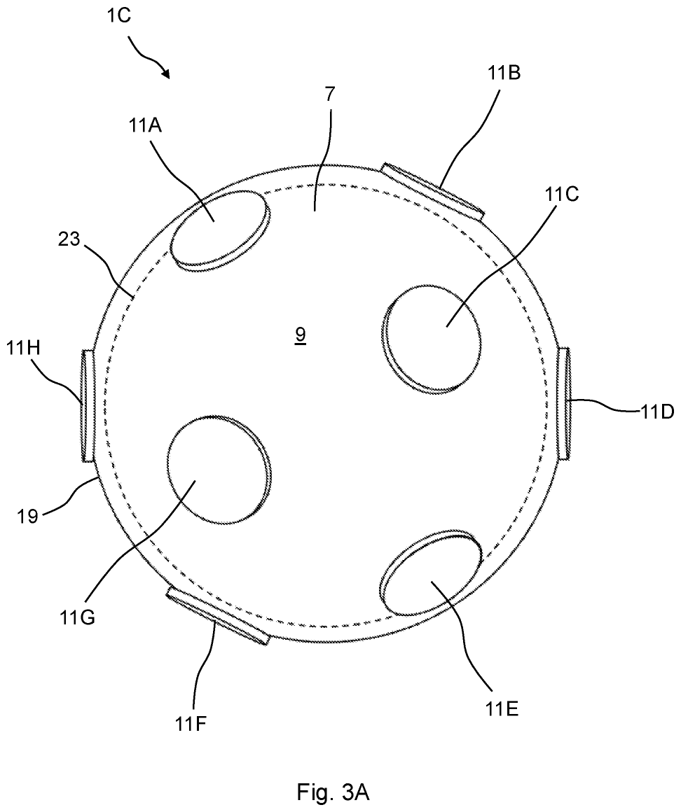

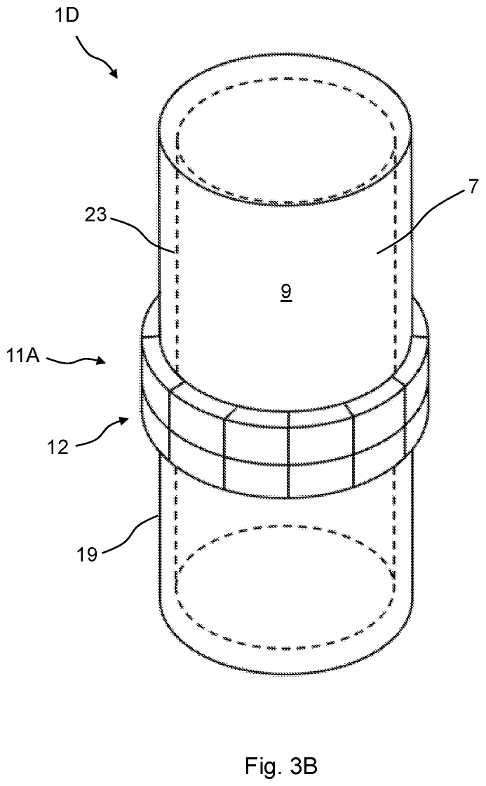

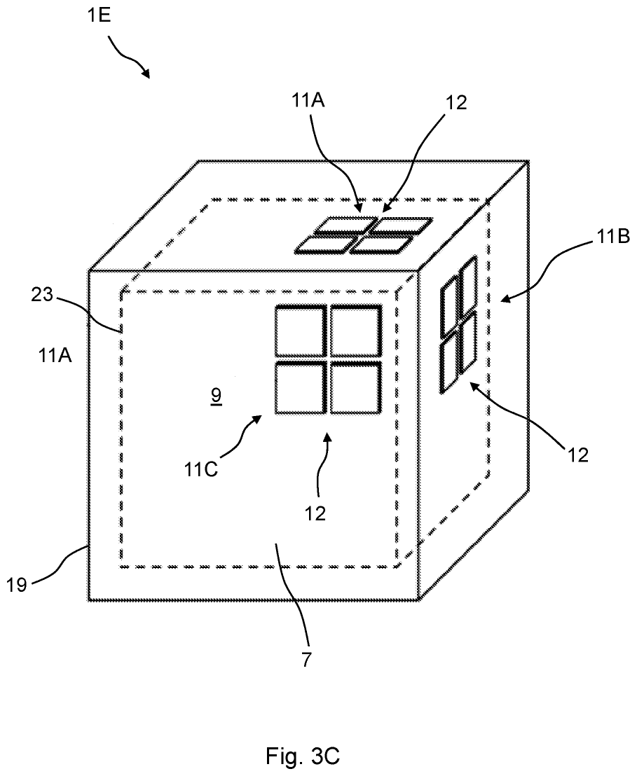

FIGS. 3A-3C show schematically elements of other exemplary embodiments of an apparatus for producing an object by means of additive manufacturing, according to the first aspect of the present disclosure;

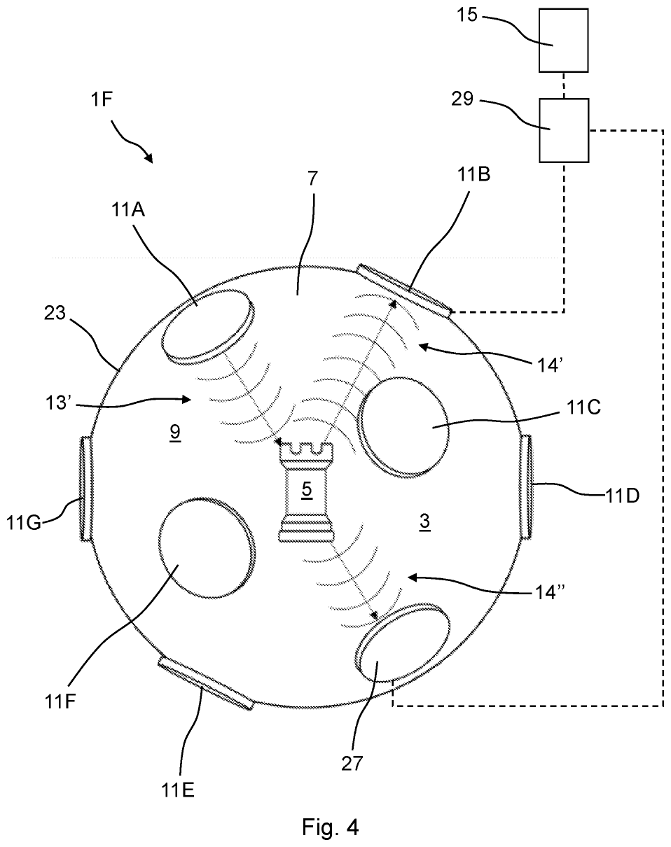

FIG. 4 shows schematically yet another exemplary embodiment of an apparatus for producing an object by means of additive manufacturing, according to the first aspect of the present disclosure;

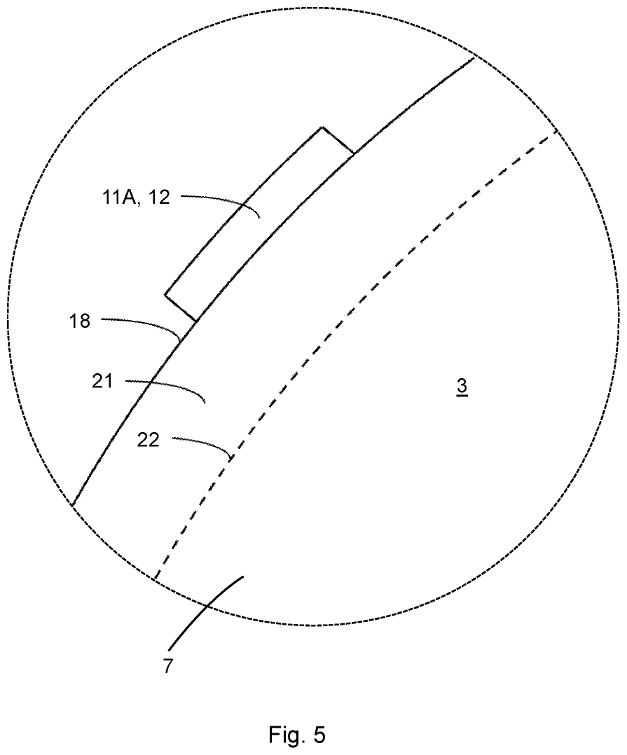

FIG. 5 shows schematically in more detail an exemplary embodiment that includes a temperature management arrangement according to an aspect of the present disclosure;

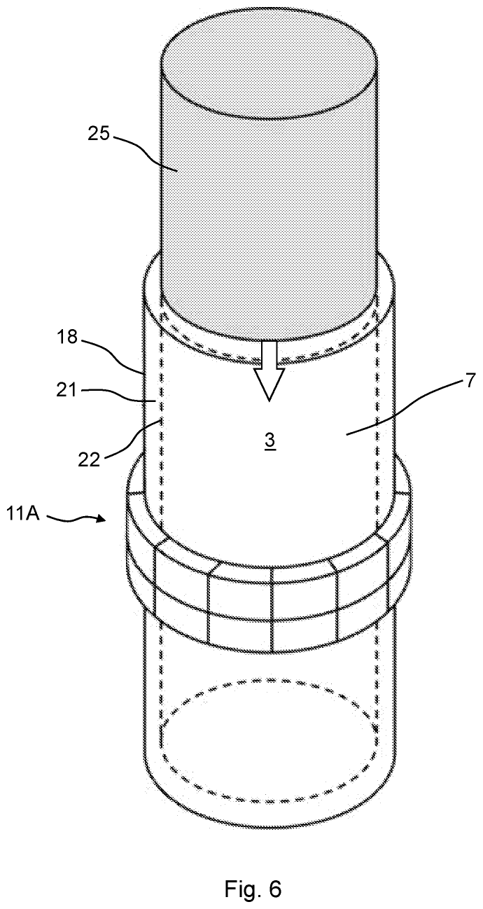

FIG. 6 shows schematically an exemplary embodiment that includes a compacting arrangement according to an aspect of the present disclosure;

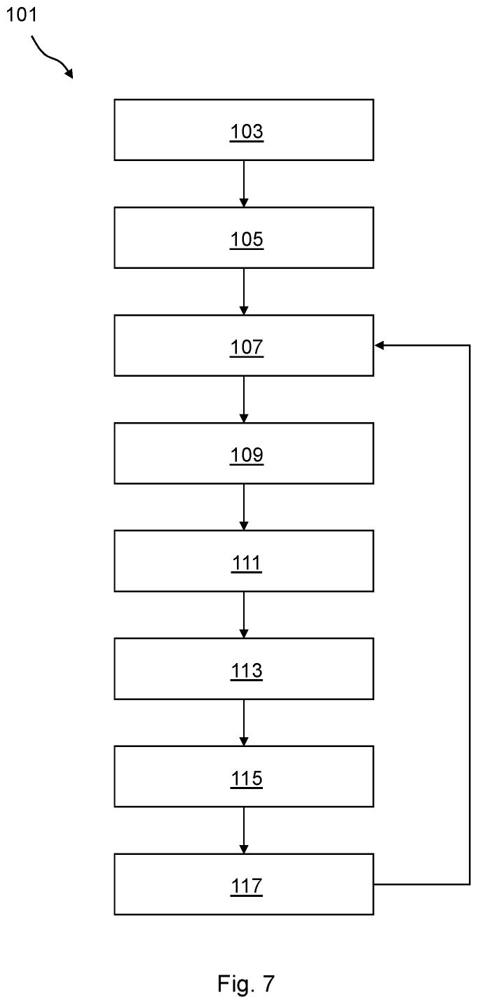

FIG. 7 shows schematically a method for producing an object by means of additive manufacturing, according to the second aspect of the present disclosure;

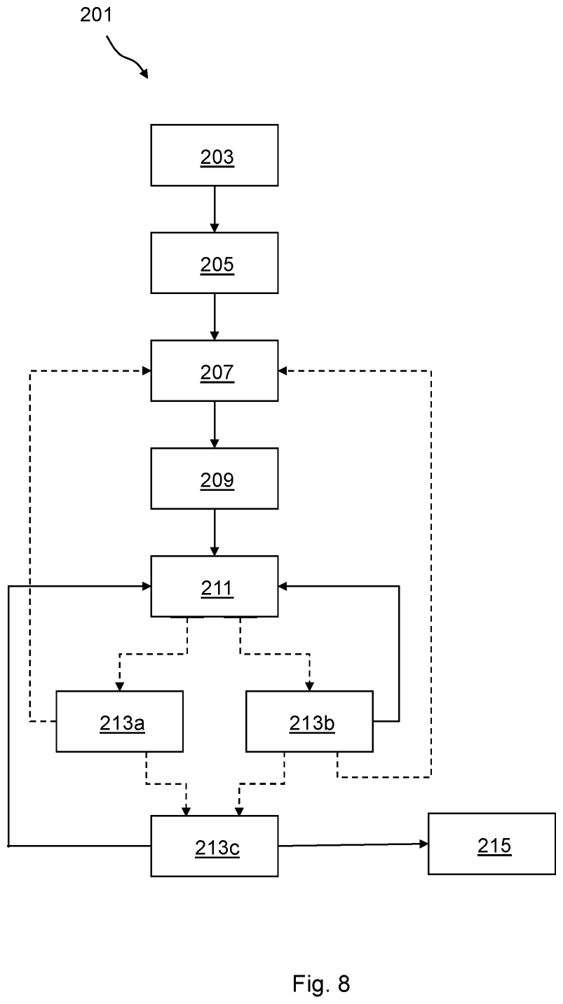

FIG. 8 shows schematically another method for producing an object by means of additive manufacturing, according to the second aspect of the present disclosure.

FIG. 1 shows an apparatus 1A for producing an object 5 by means of additive manufacturing. The apparatus 1A comprises a process chamber 7 arranged for receiving a bath of material 3 in a build space 9 of the process chamber 7. The material 3 received in the process chamber 7, can be any material suitable for producing the object 5, which can be any article or portion(s) thereof, capable of being produced according to the present disclosure. Examples include polymeric materials, metals, and combinations thereof. One or more materials 3 may be provided, where applicable, in the form of powders, granulates, liquids or suspensions. Material(s) 3 can also be provided in the form of a powder/particulate and a filler, where the filler can be a liquid, polymer, etc.

While not wishing to be bound by any particular theory, the inventors found that ultrasound energy loss reduces when the gas phase (typically, air) is reduced or removed. The ultrasound energy should be concentrated as much as possible at the desired focal spot. A gas between the particulate will result in reflections and scatter (leading to attenuation) and hence inefficient or less efficient energy transmission through the powder/gas mixture, making the printing inefficient or ineffective. By increasing the transmission, the penetration depth increases, which is especially critical for printing larger parts.

By adding a filler, a volume fraction of the gas is replaced by one or more liquid and/or solid phase(s). The reflection between the powder and the liquid/solid phase is smaller as compared to the gas, resulting in increased efficiency. An effective filler is expected to have the following properties. A filler should be in a liquid phase at the liquification temperature of the powder. Thus, the liquification temperature of the filler should be lower than the liquification temperature of the powder. In addition, a filler material should not evaporate before the powder is liquified. Thus, the evaporation (or boiling) temperature of the filler should be higher than the liquification temperature of the powder. A suitable exemplary filler/powder combination is an oil filler with a polymeric material and/or metal powder/particulate. Another suitable filler/powder combination is a solid/solid combination at room temperature, but one of the solids becomes liquified before the mixture reaches the printing temperature. Other combinations of solids and/or liquids meeting the conditions above may be used in other exemplary embodiments of the present disclosure.

In some exemplary embodiments, a post treatment may be performed (after printing) in order to improve properties of the final part. This post treatment may include application of an external stimulant that only affects the filler (i.e. curing, reaction with a gas, chemical reaction at low temperatures, etc.). In such exemplary embodiments, a filler that is changeable by an external stimulant (e.g., photo-curable, reactive with a gas when flushed through, and/or phase-changing at a particular temperature) can be advantageously used.

In yet other exemplary embodiments, one or more of the material(s) 3 of the bath of material is characterized by a bimodal or multi-modal particle-size distribution.

In one embodiment, an average particle size of the filler material is smaller than an average particle size of the powder. For example, filler material may be characterized by an average particle size of between 0.1 micron to 100 micron, while powder may be characterized by an average particle size of between 50 micron to 500 micron. The inventors found that this also allows one to optimize of the efficiency of printing by reducing the gas phase within the material(s) 3. The smaller particles fill in the gas voids between the larger particles of the powder in the material(s) 3.

The build space 9 can be arranged for receiving a material for producing the object. In an exemplary embodiment, the inner wall 23 and/or an outer wall 19 of the process chamber 7 is shaped such that the build space 9 has a cylindrical shape. In other exemplary embodiments, the inner wall 23 and/or the outer wall 19 may be square, rectangular, cylindrical, spherical, or it may include any combination of these shapes. The build space 9 can be filled with any suitable material(s) and/or medium (or media) transmissible to ultrasound, and the choice will depend on the application.

In the process chamber 7 of the apparatus 1A, an ultrasound source element 11A is provided. The ultrasound source element 11A is communicatively coupled to a control unit 15, as indicated in FIG. 1 by the dashed line between the control unit 15 and the ultrasound source element 11A. The ultrasound source element 11A emits a beam of focused ultrasound energy 13′ in the build space 9 of the apparatus 1A for processing a selective part 4′ of the material of the bath of material 3 for producing the object 5.

Processing may comprise curing, melting and/or fusing. Alternatively or additionally, processing may comprise ablating. In an embodiment, a state transition in the batch of material is promoted by the ultrasound source element at the surface of the bath of material or inside the bath of material. Focusing an ultrasound beam is possible through multiple techniques (element shape, acoustic lenses, phased arrays, etc.), where one or more ultrasound source element may be employed.

An exemplary ultrasound source element may include a plurality of sources of ultrasound energy, which can be arranged in an array or any other suitable configuration. An array of ultrasound energy sources may include a linear array or a two-dimensional array. Sources of ultrasound energy may have any suitable shape or form. An array of ultrasound energy sources may include sources of the same and/or different shape, form and/or type.

In one embodiment, the ultrasound source element 11A comprises a one-dimensional or two-dimensional array of ultrasound transducer elements 12, schematically indicated in FIG. 1 by the five neighbouring blocks in the ultrasound source element 11A, or a collection of multiple single elements and/or transducers. In an embodiment, two or more, and, preferably, three or more ultrasound energy sources are arranged irregularly or in an irregular pattern in or about the process chamber 7. The irregular arrangement of the ultrasound light sources may be further characterized by varying distances between the sources, varying types, sizes and/or shapes of the sources and/or the sources being arranged in an asymmetrical manner. Preferably, the arrangement of a plurality of ultrasound sources is random. Arranging a plurality of ultrasound light sources in an irregular pattern helps reduce side lobes of the energy distribution in the focal area. The irregular arrangement of ultrasound energy sources may include sources of the same and/or different shape, form and/or type.

A plurality of ultrasound sources are preferably disposed in a phased configuration. In some implementations of the present disclosure, the ultrasound source element may include one or more transducers. The one or more transducers may be the same and/or different shape, form and/or type. An example of a preferred embodiment of an ultrasound source element includes a phased array ultrasound transducer. This could be a phased array such as those currently used in the medical industry or a collection/plurality of multiple or single elements/transducers or a plurality of multi-element transducers. Piezo elements which emit ultrasound are one suitable example of such elements. Ultrasound transducers are used for supplying energy to the system. They can be focused locally to apply energy at a small spot or they can supply energy to a larger volume. The acoustic energy is partly transferred into heat; thus, local heating and/or volumetric heating is possible.

In an embodiment, the transducer elements 12 are individually controlled by the control unit 15 for steering and focusing the beam of focused ultrasound energy 13′. In this way, the beam of focussed ultrasound energy 13′ directed towards the material of the bath of material 3, such that the beam of focused ultrasound energy 13′ is moveable within the bath of material 3 for producing the object 5. The control unit 15 can also be configured to control the dimensions of a focal spot f_{A} characterized by a volume V and/or the rate of heating the target material.

The control unit 15 controls the ultrasound source element 11A such that a frequency of the beam of focused ultrasound energy 13′ is set at a predetermined frequency, for example, in the range 0.02-100 MHz, taking into account a characteristic of material of the bath of material 3 in a focal spot f_{A} of the beam of focused ultrasound energy 13′. The characteristic of material of the bath of material 3 is an acoustic absorption of propagating ultrasound waves. The focal spot f_{A} is moveable within the bath of material 3 for producing the object 5. In this regard it is noted that in FIG. 1 the focal spot f_{A} is provided near an upper side of the bath of material 3, but that during the production of the object 5, the focal spot f_{A} may be moved to lower parts of the bath of material 3 that are at a relative large distance from the upper side of the bath of material 3.

Additionally, the control unit 15 controls the ultrasound source element 11A such that a frequency of the beam of focused ultrasound energy 13′ is set at a predetermined frequency, for example, in the range 0.02-100 MHz, taking into account a focus distance f_{D} of the beam of focused ultrasound energy 13′.

Preferably, the predetermined frequency is set such that absorption of the beam of focused ultrasound energy reduces for an increasing focus distance of the beam of focused ultrasound energy. Additionally, or alternatively, the control unit 15 controls the ultrasound source element 11A such that an amplitude of the beam of focused ultrasound energy 13′ is set at a predetermined amplitude, taking into account a focus distance f_{D} of the beam of focused ultrasound energy 13′.

Preferably, the predetermined amplitude is set such that absorption of the beam of focused ultrasound energy reduces for an increasing focus distance of the beam of focused ultrasound energy. This allows to optimize the delivery of energy to the desired location, such as the focal spot, while managing absorption in other parts of the bath of material.

In this regard it is noted that in FIG. 1 the focal distance f_{D} is such that the focal spot f_{A} is provided near an upper side of the bath of material 3, but that during the production of the object 5, the focal distance f_{D} may be increased for moving the focal spot f_{A} to lower parts of the bath of material 3 that are at a relative large distance from the upper side of the bath of material 3.

By controlling the frequency and/or the amplitude of the beam of focused ultrasound energy 13′ and steering the beam of focused ultrasound energy 13′ as described above, the energy emitted by the beam of focused ultrasound energy 13′ can be tuned for the optimum desired processing conditions, such as curing, melting, fusing and/or ablating, the selective part 4′ of the material of the bath of material 3 for producing the object 5. In an embodiment, different materials fractions during the manufacturing of the object 5 can be used for the material of the bath material 3, wherein the acoustic absorption the beam of focused ultrasound energy 13′ is different for the two material fractions.

The ultrasound source element 11A may be attached to the inner wall 23 and/or outer wall 19 of the process chamber 7. The apparatus 1A furthermore may comprise a movement arrangement 17′, for example a rail, for moving the ultrasound source element 11A via the rail along an inner wall 23 and/or outer wall 19 of the process chamber 7, and a temperature management arrangement 21, for heating and/or cooling the process chamber 7 to a predetermined temperature. The predetermined temperature is selected based on the material to be processed and the desired type of processing. The temperature management arrangement 21 is communicatively coupled to the control unit 15, as indicated by the dashed line in FIG. 1 between the control unit 15 and the temperature management arrangement 21. The predetermined, e.g., preheated, temperature can be, for example, in the range of 5° C.-25° C. below a temperature for inducing a phase transition of the material to be processed and, preferably, in the range of 5° C.-25° C. below a temperature for curing, melting and/or fusing a selective part 4′ of the material of the bath of material 3 for producing the object 5. In some embodiments, the predetermined temperature is defined for ablating a selective part 4′ of the material of the bath of material 3 for producing the object 5.

FIG. 2 shows another embodiment of an apparatus 1B for producing an object 5 by means of additive manufacturing. The apparatus 1B relies on the same principles as the apparatus 1A, with that difference that the apparatus 1B comprises a first ultrasound source element 11A, which may include one or more ultrasound transducer elements 12, and a second ultrasound source element 11B, which may include one or more ultrasound transducer elements 12. In some implementations of the present disclosure, two or more ultrasound energy sources may include sources of the same and/or different shape, form and/or type

The two ultrasound source elements 11A, 11B are communicatively coupled to the control unit 15, as indicated in FIG. 2 by the dashed line between the control unit 15 and the first ultrasound source element 11A, and the dashed line between the control unit 15 and the second ultrasound source element 11B. The control unit 15 controls the individual ultrasound source elements 11A, 11B for emitting two different beams of focused ultrasound energy 13′, 13″ in the build space 9 of the apparatus 1B, having two different focal spots, for simultaneously processing, e.g., curing, melting, fusing and/or ablating, two different selective parts 4′, 4″ of the material of the bath of material 3 for producing the object 5.

Other exemplary embodiments may include more than two ultrasound source elements 11A, 11B communicatively coupled to the control unit 15. The beams of focused ultrasound energy, e.g., 13′, 13″, may be directed to different positions in the bath of material, such that the focal spots of at least two beams of focused ultrasound energy, e.g., 13′, 13″, are formed in different locations. In some exemplary embodiments, the control unit 15 controls the individual ultrasound source elements, e.g., 11A, 11B, to make different parts of an object. In an embodiment, the control unit 15 can control and direct different beams of focused ultrasound energy, e.g., 13′, 13″, to form focal spots in a plurality of different locations, which is advantageous for creating holograms. Alternatively, beams of focused ultrasound energy, e.g., 13′, 13″, may be directed to the same position in the bath of material. In such exemplary embodiments, the focal spots of at least two beams are formed in the same or approximately the same location.

A first ultrasound source element 11A or a first plurality of ultrasound source elements may be arranged for emitting a first beam of focused ultrasound energy 13′ that is characterized by a first frequency and a first amplitude. A second ultrasound source element 11B or a second plurality of ultrasound source elements may be arranged for emitting a second beam of focused ultrasound energy 13″ that is characterized by a second frequency and a second amplitude. The first frequency and/or amplitude may be the same or different as the second frequency and/or amplitude.

To increase the amount of energy at larger depth, it is advantageous to reduce the frequency as the depth is increased. Hence, low frequencies are preferably used for parts that are far away from the source and higher frequencies-for parts closer to the source. One possible problem would be: the resolution of the parts that are deeper will decrease with the decrease in frequency. However, the resolution can be improved if the amplitude of the ultrasound wave is also controlled, e.g., by controlling the amplitude of one or more of the ultrasound source elements/transducers. One or more ultrasound source elements that are closer to the focal spot preferably have a lower amplitude than one or more ultrasound source elements that are further away from the focal spot. With this apodization strategy the spot size can be kept more consistent or even constant throughout the volume.

The individual ultrasound source elements 11A, 11B are controlled in the same way by the control unit 15 as the single ultrasound source elements 11A as described above. Using multiple ultrasound source elements 11A, 11B for producing the object 5 allows realizing a relative short processing time for producing the object 5.

The ultrasound source elements 11A, 11B may be attached to the inner wall 23 and/or outer wall 19 of the process chamber 7. Furthermore, the apparatus 1B may be provided with a plurality of movement arrangements, such as two rails 17′, 17″, for moving the respective ultrasound source elements 11A, 11B via the rails 17′, 17″ along an inner wall 23 and/or outer wall 19 of the process chamber 7. Additional or substitutive ultrasound source element 11A, 11B can be provided for moving along an upper wall and/or along the circumference of the process chamber 7 of the apparatus 1B.

The circumference of the process chamber 7 can have any suitable shape, such as cylindrical, square, rectangular, spherical or a combination of any of these shapes. The shape may be selected, for example, depending on the part that needs to be built. Furthermore, one and/or multiple ultrasound source elements 11A, 11B can be installed statically on a side wall and/or upper wall of the process chamber 7 of the apparatus 1A, 1B. Where the process chamber 7 has a generally cylindrical shape, ultrasound source elements 11A, 11B can be placed along a generally circular 2D cross section of a cylinder. In an embodiment, two or more, and, preferably, three or more ultrasound energy sources, such as ultrasound source elements 11A, 11B, are arranged irregularly or in an irregular pattern on the inner wall 23 and/or outer wall 19 of the process chamber 7.

FIGS. 3A, 3B and 3C show other exemplary embodiments of an apparatus 1C, 1D and 1E respectively, for producing an object 5 by means of additive manufacturing. The apparatuses 1C-1E rely on the same principles as the apparatuses 1A, 1B as described above. For clarity, not all elements of the apparatuses 1C-1E are shown in the respective figures. However, the description of the embodiments and/or advantages and/or effects of apparatus 1A, 1B can be applied mutatis mutandis to the apparatus 1C-1E, as will be clear for the person skilled in the art. For example, two or more, or all ultrasound energy sources of these exemplary embodiments may be arranged irregularly or in an irregular pattern on the inner wall and/or outer wall of the process chamber of the apparatus 1C-1E.

FIG. 3A shows an embodiment of an apparatus 1C for producing an object by means of additive manufacturing. In this exemplary embodiment, the inner wall 23 and the outer wall 19 of the process chamber 7 are shaped such that the build space 9 define a spherical volume. The apparatus 1C comprises at least 8 ultrasound source elements 11A-11H arranged on the outer wall 19 of the process chamber 7. Each ultrasound element 11A-11H comprises one or more ultrasound transducer elements 12. The ultrasound transducer elements 12 can have any suitable shape, which can be optimized for the shape of the bath of material 3 received in the process chamber 7. Using multiple ultrasound source elements 11A-11H for producing the object, allows realizing a relative short processing time for producing the object.

FIG. 3B shows an embodiment of an apparatus 1D for producing an object by means of additive manufacturing. In this exemplary embodiment, the inner wall 23 and the outer wall 19 of the process chamber 7 are shaped such that the build space 9 define a cylindrical volume. The apparatus 1D comprises an ultrasound source element 11A arranged on the outer wall 19 of the process chamber 7. The ultrasound element 11A comprises a two-dimensional array of ultrasound transducer elements 12. The ultrasound transducer elements 12 can have any suitable shape, which can be optimized for the shape of the bath of material 3 received in the process chamber 7.

FIG. 3C shows an embodiment of an apparatus 1E for producing an object by means of additive manufacturing. In this exemplary embodiment, the inner wall 23 and the outer wall 19 of the process chamber 7 are shaped such that the build space 9 define a cubic volume. The apparatus 1E comprises at least 3 ultrasound source elements 11A-11C arranged on the inner wall 23 and/or the outer wall 19 of the process chamber 7. Each ultrasound element 11A-11C comprises 4 ultrasound transducer elements 12, arranged in a two-dimensional array of ultrasound transducer elements 12. The ultrasound transducer elements 12 can have any suitable shape, which can be optimized for the shape of the bath of material 3 received in the process chamber 7.

In another embodiment, the apparatus 1E alternatively or additionally comprises a plurality of collections of multiple ultrasound source elements, arranged in a two-dimensional array of ultrasound source elements, arranged on the inner wall 23 and/or the outer wall 19 of the process chamber 7.

FIG. 4 shows another exemplary embodiment of an apparatus 1F for producing an object by means of additive manufacturing. The apparatus 1F comprises a process chamber 7 arranged for receiving a bath of material 3 in a build space 9 of the process chamber 7.

The description below can be applied mutatis mutandis to the above description of other embodiments of the apparatus 1A-1E of the present disclosure, as will be clear for the person skilled in the art.

In this exemplary embodiment, one or more ultrasound source elements 11A-11G are further arranged for receiving an echo 14′, 14″ from the build space 9 originating from a reflection of the beam of focused ultrasound energy 13′. Additionally or alternatively, separate receiver elements 27 may be provided for the purpose of receiving the echo 14′, 14″. One or more sources of ultrasound energy 11A-11G and/or separate receiver elements 27 are arranged to output a signal comprising data related to the echo 14′, 14″ received. The apparatus 1F further comprises a determining unit 29, communicatively coupled to the ultrasound source element 11A-11G and/or the receiver element 27. The determining unit 29 is arranged for receiving the output signal and processing the data related to the echo 14′, 14″ for determining a parameter of the bath of material 3. The determining unit 29 is communicatively coupled to the control unit 15 and arranged for providing control data to the control unit 15 for controlling the ultrasound source element 11A-11G taking into account the parameter determined by the determining unit 29.

For clarity, in FIG. 4 only a communicatively coupling between ultrasound element 11B and the determining unit 29, and a communicatively coupling between receiver element 27 and the determining unit 29 is shown by the dashed lines. However, preferably, all ultrasound source elements 11A-11G and receiver elements 27 are communicatively coupled to the determining unit 29 and/or the control unit 15.

One or more sources of ultrasound energy 11A-11G, such as one or more ultrasound transducers, are used to send an ultrasound wave 13′ to the object 5. Because of the density difference between the object 5 and the surrounding bath of material 3, the ultrasound wave 13′ will reflect from the surface of the object 5. Switching from sending to receiving a plurality of transducers can be used to receive the reflection. Additionally or alternatively, separate transducers/receivers could be used just for receiving the reflections. From these reflections, image reconstruction techniques can be employed to visualize the object 5 inside the batch of material 3.

By recording echoes 14′, 14″ from the build space 9, it is possible to visualize the scanning inside the bath of material 3. These imaging techniques are widely used in medical applications. This imaging opens the opportunity to correct print parameters during the production of the object 5. Hence, the manufacturing procedure is tuneable so that the object 5 is produced in the right manner the first time and every time. In this way, the echoes 14′, 14″ are used to visualize and adjust the printing process accordingly.

FIG. 5 shows a section of an exemplary apparatus 1A-1F for producing an object 5 by means of additive manufacturing. The apparatus 1A-1F comprises a process chamber 7 arranged for receiving a bath of material or materials 3 used for printing the object 5. The exemplary apparatus 1A-1F includes a source of ultrasonic energy 11A, such as an ultrasound transducer 12 with a send and/or a receive function disposed at a first interface 18, wherein the first interface 18 for example comprises or is provided in the outer wall 19.

The first interface 18 preferably includes a coupling layer that promotes efficient transmission of ultrasound waves by acoustically connecting the source of ultrasonic energy 11A and the material of the coupling layer and removing or reducing the amount of gas that could be in-between. On one hand, this means that the impedance mismatch between the coupling layer and the print material should be low, which will limit the reflection at the first interface 18. On the other hand, the coupling layer preferably has a low ultrasound absorption. Otherwise, energy will be lost before it passes the first interface 18 and the bath of material 3. The preferred material for the coupling layer in case of printing polymers would be a high temperature liquid coupling media that is capable of handling temperatures up to the printing temperature. This is also applicable for metals and ceramics.

The first interface 18 is disposed between the ultrasonic source element 11A and the temperature management arrangement 21, which in this exemplary embodiment includes a cooling and/or heating medium, that is communicatively coupled to a control unit 15 (not shown in FIG. 5), for heating and/or cooling the process chamber 7 to a predetermined temperature. The temperature management arrangement 21 and the bath of material 3 are separated by a second interface 22, Wherein the first interface 18 for example comprises or is comprised in the inner wall 23.

If the cooling and/or heating medium of the temperature management arrangement 21 is a solid, then the first interface 18 may advantageously include a coupling layer that consist of or includes a liquid. Non-limiting examples of suitable liquids include a coupling gel, some oils, water, and/or glues. Additionally or alternatively, the first interface 18 could include one or more solids. On the other hand, if the cooling and/or heating medium of the temperature management arrangement 21 is a liquid, then the ultrasound transducer 12 could be submerged therein and then the first interface 18 is the same as the temperature management arrangement 21.

The ultrasound transducer 12 can have any suitable shape. For example, it can be flat or curved with a focal point. If the printer surface is curved, it is advantageous in terms of energy transmission that the shape of one or more ultrasound energy sources 11A matches the curvature of the printer surface, e.g, the curvature of the process chamber 7. This helps reduce the distance that a wave has to travel towards the bath of material 3. In addition, to facilitate the movement of one or more ultrasound energy sources 11A with respect to an inner wall 23 or outer wall 19 of the printer, the shape of the one or more ultrasound energy sources 11A should match the curvature of the printer to ensure contact.

The temperature management arrangement 21 can function, for example as a heat sink for cooling the batch of material 3. In such exemplary embodiments, the interface cooling material does not change phase above a predetermined initial temperature for printing. For example, a liquid interface does not boil/evaporate and a solid does not become liquidous above a predetermined initial temperature for printing.

Several methods can be used for heating and/or cooling, depending on the cooling and/or heating medium of the temperature management arrangement 21. In one embodiment, the temperature management arrangement 21 utilizes a cooling liquid flowing at a predetermined temperature within a chamber formed, for example, between the first interface 18 and the second interface 22. The temperature of the liquid can be externally regulated by standard techniques (heating/cooling rod, evaporation, etc.). Additionally or alternatively, the temperature management arrangement 21 utilizes a solid comprising small channels implemented with a liquid to regulate the temperature of the solid. Copper is one example of a suitable solid. Or the surface area of the temperature management arrangement 21 can be extended by for example fins.

The material(s) of the temperature management arrangement 21 are preferably used to acoustically couple the source of ultrasound energy 11A with the bath of material 3. Moreover, the material(s) of the temperature management arrangement 21 are used as a thermal coupling between the source of ultrasound energy 11A with the bath of material 3, and as a thermal coupling between the environment and the bath of material 3, as explained above. Additional heating and/or cooling elements can be provided inside or on the surface of the first interface 18 and/or inside the heat management arrangement 21. For example, the ultrasound elements 11A could be cooled by an airflow outside of the first interface 18 (or any other type of cooling method), while the bath of material 3 can be cooled by a liquid material (in the temperature management arrangement 21) flowing over the second interface 22. In an embodiment, cooling and/or heating can be performed by, for example, heat convection with a flow of a gas or heat conduction with the flow of a liquid. Cooling can also be achieved by using for example cooling fins disposed on the first interface 18.

The second interface 22 and/or the first interface 18 may consist of or include multiple layers and/or materials. In one embodiment, the second interface 22 could be used to separate a liquid in the temperature management arrangement 21 from the bath of material 3. Then the second interface 22 preferably includes one or more solid layers. Several solid layers would be preferable in case of an impedance mismatch between the material in the temperature management arrangement 21 and the bath of material 3 in order to reduce the acoustic reflection at the second interface 22. The layers all should not change phase at the predetermined initial temperature as mentioned above. The impedance of the layers is preferable between the impedance of the material in the temperature management arrangement 21 and the bath of material 3, to decrease the reflection.

As may be clear from the above description, the temperature management arrangement 21 of the apparatus 1A-1F is a separate unit, for example a heating arrangement and/or a cooling arrangement for heating and/or cooling the process chamber 7 and/or the bath of material 3 to a predetermined temperature, as for example shown in FIGS. 1 and 2. The temperature management arrangement 21 is for example arranged along the first interface 18 and/or the second interface 22 and/or the outer wall 19 and/or the inner wall 23 of the process chamber 7. Additionally or alternatively, the temperature management arrangement 21 comprises a cooling and/or heating medium, arranged along the first interface 18 and/or the second interface 22 and/or the outer wall 19 and/or the inner wall 23 of the process chamber 7, for heating and/or cooling the process chamber 7 and/or the bath of material 3 to a predetermined temperature, as for example shown in FIG. 5. Furthermore, other embodiments of the temperature management arrangement 21 are possible, as will be clear for the person skilled in the art.

FIG. 6 shows schematically an exemplary embodiment that includes a compacting arrangement 25 according to an aspect of the present disclosure. Preferably, the shape of the compacting arrangement 25 is adjusted to fit the shape of the process chamber 7 of the apparatus 1A-1F. The description below can be applied mutatis mutandis to the above description of other embodiments of the apparatus 1A-1F of the present disclosure, as will be clear for the person skilled in the art.

In this exemplary embodiment, compaction is performed by the compacting arrangement 25 inside the process chamber 7. In other exemplary embodiments, the compaction may be performed by the compacting arrangement 25 before the bath of material 3 is received in the process chamber 7.

The compacting arrangement 25 is movably mounted on the apparatus 1A-1F. In FIG. 6, the apparatus 1A-1F comprises a temperature management arrangement 21 as described in FIG. 5, wherein the temperature management arrangement 21 comprises a cooling and/or heating medium, arranged along the first interface 18 and/or the second interface 22 and/or the outer wall 19 and/or the inner wall 23 of the process chamber 7, for heating and/or cooling the process chamber 7 and/or the bath of material 3 to a predetermined temperature. However, other embodiments of the temperature management arrangement 21 are possible. The compacting arrangement 25 is arranged to be moved down, so that the bath of material 3 is compacted. With compacting is meant that the density of the bath of material 3 increases. In terms of volume this would mean that less volume is available for the bath of material 3 to be in the process chamber 7. In this case, the density increase of the bath of material 3 is due to the downward motion of the compaction device 25, such as a piston.

Preferably, in case of a cylinder or powder sphere, the compaction and/or compression of the bath of material 3 is performed before the additive manufacturing of the object. In case of a cylinder, compression and/or compaction is for example is done by using a single-piston compression. In case of a sphere, compaction and/or compressing is preferably done by compacting and/or compressing the sphere using multiple compacting components applying compressive force from different sides.

An advantage of compaction is that, by reducing the total volume of the bath of material 3, it reduces the gas phase between the powder particles. Therefore, the reflections in this volume are reduced and the efficiency increases, as explained above. A liquid/powder containing bath of material 3 can also benefit from compaction, e.g., to change or reduce the liquid fraction, and, more generally, to change or reduce the fraction of the filler material. This enables further reducing the pore size of the final 3D printed product.

FIG. 7 shows schematically a method 101 for producing an object by means of additive manufacturing. The method 101 comprises the steps of compacting 103, receiving a bath of material 105, emitting 107, controlling 109, receiving the echo 111, outputting 113, determining 115 and providing control data 117.

In a first step of compacting 103, the bath of material 3 is compacted and/or compressed for producing the object 5.

In a next step of receiving 105, a bath of material 3 arranged for producing the object 5 is received in the build space 9 of the process chamber 7. The material 3 comprises two material fractions, wherein a frequency dependent acoustic absorption of propagating ultrasound waves is different for the two material fractions.

During the step of emitting 107, a beam of focused ultrasound energy 13′, 13″ is emitted by the ultrasound source element 11A-11H in the build space 9 of the apparatus 1A-1F for processing, such as curing, melting, fusing, and/or ablating, a selective part 4′, 4″ of the material(s) of the bath of material 3 for producing the object 5.

During the step of controlling 109, the ultrasound source element 11A-11H is controlled by the control unit 15, such that a frequency and/or amplitude of the beam of focused ultrasound energy 13′, 13″ is set at a predetermined value(s) taking into account a characteristic of material of the bath of material 3 in a focal spot f_{A} of the beam of focused ultrasound energy 13′, 13″ and/or such that the frequency and/or the amplitude of the beam of focused ultrasound energy 13′, 13″ is set at a predetermined value(s) taking into account a focus distance f_{D} of the beam of focused ultrasound energy 13′, 13″.

During the step of controlling 109, in some embodiments, the predetermined frequency is set to a frequency corresponding to 80% to 100% of a maximum of the frequency dependent acoustic absorption of propagating ultrasound waves of the material 3, and is set such that absorption of the beam of focused ultrasound energy 13′, 13″ reduces for an increasing focus distance f_{D} of the beam of focused ultrasound energy 13′, 13″.

During the step of receiving the echo 111, the echo 14′, 14″ from the build space 9 originating from the reflection of the beam of focused ultrasound energy 13′, 13″ is received by the ultrasound source element 11A-11H and/or the receiver elements 27.

During the step of outputting 113, an output signal comprising data related to the echo 14′, 14″ received is outputted, by the ultrasound source element 11A-11H and/or the receiver elements 27, to the determining unit 29, for determining 115 a parameter of the bath of material 3.

During the step of providing 117, control data is provided, by the determining unit 29, to the control unit 15 for controlling the ultrasound source element 11A-11H taking into account the parameter.

The steps of emitting 107, controlling 109, receiving the echo 111, outputting 113, determining 115 and providing control data 117 are repeated until the object 5 is finished.

Furthermore, during the steps of emitting 105 and controlling 107, the process chamber 7 is heated and/or cooled, by the temperature management arrangement 21, to a predetermined temperature that is in the range of 5° C.-25° C. below a temperature for curing, melting and/or fusing a selective part 4′, 4″ of the material of the bath of material 3 for producing the object 5. In one embodiment, ultrasound sources may be employed for pre-heating.

FIG. 8 shows schematically a method 201 for producing an object by means of additive manufacturing. The description of the embodiments and/or advantages and/or effects of method 201 can be applied mutatis mutandis to the method 101, as will be clear for the person skilled in the art. The method 201 comprises the step of preparing 203 the bath of material 3 by for example mixing the different materials and/or (optionally) compacting. This also may involve making the bath of material 3 in the desired volume shape;

Method 201 further comprises the steps of:
loading 205 the bath of material 3 in the printer, controlling 207 the temperature of the printer and bath of material 3 to predetermined values;
using 209 the one or more ultrasound sources 11A-11H to focus at the desired location(s) with a predetermined amplitude and number of active transducers, and using the difference in timing between the ultrasound sources 11A-11H to steer the focal spot through the volume of the bath of material 3;
determine 211 the number of active ultrasound sources 11A-11H (and the ones that are active), the amplitude of each ultrasound source 11A-11H, and the timing of each ultrasound source 11A-11H to generate a scan path.

For the purpose of the step of determine 211, the change in material phases, mechanical properties or acoustical properties during printing (e.g. melting of powder induces a change in density and thus speed of sound and attenuation), as well as other parameters of the bath of material 3, may be taken into account. This relies on the presence of different material states during the scan.

Method 201 further may comprise step 213a wherein the scan settings determined during step 211 are used. Step 213a may be followed by step 213c or 207.

Alternatively, method 201 may comprise step 213b wherein a part/or all of the ultrasound sources 11A-11H or an extra set of ultrasound sources 11A-11H or separate receiver elements 27 are used to generate an “image” of volumes of the bath of material 3 with a change in acoustical or mechanical properties. This is similar to an echo in medical applications where you can e.g. visualize a baby in the womb of a mother. This allows for the scan parameters to be corrected in-situ. Step 213b may be followed by step 211 or if the part is completed followed by step 213c or step 207.

Method 201 may comprise step 213c, in combination with step 213a and/or step 213b wherein one or more parameters, such as flaws or other acoustical or mechanical properties, in the bath of material 3 are detected. This means in the bath of material 3 that has not yet been scanned, but also in the bath of material 3 that is being printed or that has been printed partly/in total. The flaws may be corrected by looping recalculating the scanning parameters and scanning again. This is done by looping back to step 211. If the part is totally scanned, step 213c may be followed by step 207.

During a step 207 of the method 201, the temperature of the printer and/or bath of material is controlled. This may involve cooling down to induce another phase transition (e.g. after melting going back to the solid phase) and/or just so that the volume of material can be taken out of the build chamber.

During a step 15 of the method 201, the bath of material is removed from the printer.

1. An apparatus for producing an object by means of additive manufacturing, the apparatus comprising:
a process chamber arranged for receiving in a build space of the process chamber a bath of material arranged for producing the object;
an ultrasound source element arranged for emitting a beam of focused ultrasound energy in the build space for processing a selective part of the material of the bath of material for producing the object;
a control unit, communicatively coupled to the ultrasound source element, arranged for controlling the ultrasound source element such that a frequency and/or an amplitude of the beam of focused ultrasound energy is set at a predetermined value taking into account a characteristic of material of the bath of material in a focal spot of the beam of focused ultrasound energy.

2. The apparatus according to claim 1, wherein the control unit is further arranged for controlling the ultrasound source element such that the frequency and/or the amplitude of the beam of focused ultrasound energy is/are set at the predetermined value taking into account a focus distance of the beam of focused ultrasound energy.

3. The apparatus according to claim 1, wherein the apparatus comprises a compacting arrangement arranged for compacting the bath of material provided in the process chamber.

4. The apparatus according to claim 1, wherein the apparatus further comprises a temperature management arrangement, communicatively coupled to the control unit, for heating and/or cooling the process chamber to a predetermined temperature.

5. (canceled)

6. The apparatus according to claim 1, wherein the ultrasound source element is further arranged for receiving an echo from the build space originating from a reflection of the beam of focused ultrasound energy and arranged for outputting an output signal comprising data related to the echo received, wherein the apparatus further comprises:
a determining unit, communicatively coupled to the ultrasound source element, arranged for receiving the output signal and processing the data related to the echo for determining a parameter of the bath of material.

7. The apparatus according to claim 6, wherein the determining unit is communicatively coupled to the control unit and further arranged for providing control data to the control unit for controlling the ultrasound source element taking into account the parameter determined by the determining unit.

8. (canceled)

9. The apparatus according to claim 1, wherein the control unit is arranged for controlling the ultrasound source element such that the beam of focused ultrasound energy is moveable within the bath of material for producing the object.

10. (canceled)

11. The apparatus according to claim 1, wherein an inner wall and/or an outer wall of the process chamber is shaped such that the build space has a spherical shape and/or a cylindrical shape.

12. The apparatus according to claim 1, wherein the apparatus further comprises a plurality of the ultrasound source elements and wherein the control unit is arranged for controlling the plurality of ultrasound source elements simultaneously for producing the object using a plurality of beams of focused ultrasound energy emitted by the plurality of ultrasound source elements.

13. The apparatus according to claim 1, wherein the apparatus comprises a first ultrasound source element/plurality of ultrasound source elements arranged for emitting a first beam of focused ultrasound energy and a second ultrasound source element/plurality of ultrasound source elements arranged for emitting a second beam of focused ultrasound energy, wherein the first beam of focused ultrasound energy is characterized by a first frequency and a first amplitude and the second beam of focused ultrasound energy is characterized by a second frequency and a second amplitude, the first frequency and/or amplitude being different from the second frequency and/or amplitude.

14. (canceled)

15. The apparatus according to claim 1, wherein the process chamber is arranged for receiving at least one of a powder material for producing the object and a mixture of the powder material for producing the object and a filler material, such as a liquid or solid filler material.

16. A method for producing an object by means of additive manufacturing, the method comprising the steps of:
receiving, in a build space of a process chamber a bath of material arranged for producing the object;
emitting, by an ultrasound source element, a beam of focused ultrasound energy in the build space for processing a selective part of the material of the bath of material for producing the object;
controlling , by a control unit, the ultrasound source element such that a frequency and/or amplitude of the beam of focused ultrasound energy is set at a predetermined value taking into account a characteristic of material of the bath of material in a focal spot of the beam of focused ultrasound energy.

17. The method according to claim 16, wherein, during the step of controlling, the ultrasound source element is controlled such that the frequency and/or the amplitude of the beam of focused ultrasound energy is set at the predetermined value taking into account a focus distance of the beam of focused ultrasound energy.

18. The method according to claim 16, wherein, during the step of controlling, the predetermined frequency and/or amplitude is set such that absorption of the beam of focused ultrasound energy reduces for an increasing focus distance of the beam of focused ultrasound energy.

19. The method according to claim 16, wherein, during the step of receiving, the bath of material received in the build space of the process chamber comprises two material fractions, wherein the acoustic absorption of propagating ultrasound waves is different for the two material fractions.

20. The method according to claim 16, wherein, during the steps of emitting and controlling, the process chamber is heated and/or cooled, by a temperature management arrangement, to a predetermined temperature.

21. The method according to claim 16, wherein the method further comprises the step of:
compacting the bath of material for producing the object.

22. (canceled)

23. The method according to claim 16, wherein the step of receiving comprises receiving at least one of a powder material for producing the object and a mixture of the powder material for producing the object and a filler material, such as a liquid or solid filler material.

24. (canceled)

25. The method according to claim 16, wherein the method further comprises the steps of:
receiving the echo from the build space originating from the reflection of the beam of focused ultrasound energy;
outputting an output signal comprising data related to the echo received; and
determining a parameter of the bath of material.

26. The method according to claim 25, wherein the method further comprises the step of:
providing control data to the control unit for controlling the ultrasound source element taking into account the parameter.
